(19) United States
(12) Patent Application Publication
(10) Pub. No.: US 2026/0255021 A1
(43) Pub. Date: Aug. 27, 2026

(54) VIDEO STREAM PLAYBACK METHOD AND DEVICE, STORAGE MEDIUM, AND PROGRAM PRODUCT

(71) Applicant: Beijing Zitiao Network Technology Co., Ltd, Beijing (CN)

(72) Inventor: Rusong HUAN, Beijing (CN)

(21) Appl. No.: 19/163,348

(22) PCT Filed: Mar. 5, 2024
(86) PCT No.: PCT/CN2024/080122

§ 371 Date: Sep. 8, 2025

(30) Foreign Application Priority Data
Mar. 8, 2023 (CN) 202310220622.4

(51) Int. Cl. H04N 21/462; H04N 21/44

(52) U.S. Cl. CPC H04N 21/4621; H04N 21/44004

(57) ABSTRACT

Embodiments of the present disclosure provide a video stream playback method and device, a storage medium, and a program product. The video stream playback method includes: acquiring current screen brightness of a playback device; determining target definition of a video stream according to the current screen brightness; and acquiring a video stream having the target definition, and playing back the video stream having the target definition.

### CROSS-REFERENCE TO RELATED APPLICATIONS

The present application is based on and claims priority to CN Application No. 202310220622.4, filed on Mar. 8, 2023, which is incorporated herein by reference in its entirety.

### TECHNICAL FIELD

Embodiments of the present disclosure relate to the field of computer and network communication technologies, and in particular, to a video stream playback method and device, a storage medium, and a program product.

### BACKGROUND

With the development of internet technology, live streams and other video streams may be watched in various places.

When the live streams or other video streams are played, a default playback definition is often used, which may lead to unnecessary data consumption, and result in problems such as video lag, thus affecting the viewing experience of video streams.

### SUMMARY

According to a first aspect, an embodiment of the present disclosure provides a video stream playback method. The method includes:
obtaining current screen brightness of a playback device;
determining target definition of a video stream based on the current screen brightness; and
obtaining and playing back the video stream at the target definition.

According to a second aspect, an embodiment of the present disclosure provides a video stream playback device. The device includes:
a detecting unit configured to obtain current screen brightness of a playback device;
a definition determining unit configured to determine target definition of a video stream based on the current screen brightness; and
a switching unit configured to obtain and play back the video stream at the target definition.

According to a third aspect, an embodiment of the present disclosure provides an electronic device. The electronic device includes: at least one processor and a memory, where
the memory stores computer-executable instructions; and
the computer-executable instructions stored in the memory, when executed by the at least one processor, cause the at least one processor to perform the video stream playback method according to any one of the embodiments of the present disclosure.

According to a fourth aspect, an embodiment of the present disclosure provides a computer-readable storage medium storing computer-executable instructions that, when executed by a processor, cause the video stream playback method according to any one of the embodiments of the present disclosure to be implemented.

According to a fifth aspect, an embodiment of the present disclosure provides a computer program product including computer-executable instructions that, when executed by a processor, cause the video stream playback method according to any one of the embodiments of the present disclosure to be implemented.

In a sixth aspect, according to one or more embodiments of the present disclosure, a computer program is provided, where the computer program includes instructions that, when executed by a processor, cause the processor to implement the video stream playback method according to any one of the embodiments of the present disclosure.

### BRIEF DESCRIPTION OF THE DRAWINGS

In order to describe the technical solutions in embodiments of the present disclosure or in the prior art more clearly, the accompanying drawings for describing the embodiments or the prior art will be briefly described below. Apparently, the accompanying drawings in the description below show some embodiments of the present disclosure, and those of ordinary skill in the art may still derive other accompanying drawings from these accompanying drawings without creative efforts.

FIG. 1 is an exemplary view of a scenario of a video stream playback method according to some embodiments of the present disclosure;

FIG. 2 is a schematic flowchart of a video stream playback method according to some embodiments of the present disclosure;

FIG. 3 is a schematic flowchart of a video stream playback method according to some other embodiments of the present disclosure;

FIG. 4 is a schematic flowchart of a video stream playback method according to yet some other embodiments of the present disclosure;

FIG. 5 is a schematic flowchart of a video stream playback method according to still some other embodiments of the present disclosure;

FIG. 6 is a block diagram of a structure of a video stream playback device according to some embodiments of the present disclosure; and

FIG. 7 is a schematic diagram of a hardware structure of an electronic device according to some embodiments of the present disclosure.

### DETAILED DESCRIPTION

In order to make the objectives, technical solutions, and advantages of embodiments of the present disclosure clearer, the technical solutions in the embodiments of the present disclosure will be described clearly and completely below with reference to the accompanying drawings in the embodiments of the present disclosure. Apparently, the embodiments described are some rather than all of the embodiments of the present disclosure. All other embodiments obtained by those of ordinary skill in the art based on the embodiments of the present disclosure without any creative effort shall fall within the scope of protection of the present disclosure.

In use for playback of live streams or other video streams, a playback device typically uses a default definition for playback, which may lead to unnecessary data consumption, and result in problems such as video lag, thus affecting the viewing experience of video streams.

In order to solve the above technical problems, the present disclosure contemplates that when current screen brightness of the playback device is low, the resolution of the video stream has little influence on the video viewing experience, so that the video stream can be played at a low resolution (e.g., a first resolution) to avoid unnecessary data consumption and video lag. In contrast, when the current screen brightness is high, the resolution of the video stream has a great influence on the video viewing experience, so that the video stream can be played at a high resolution (e.g., a second resolution, which is higher than the first resolution) to ensure the viewing experience of the video stream. Therefore, an embodiment of the present disclosure provides a video stream playback method. The method includes: obtaining current screen brightness of a playback device; determining target definition of a video stream based on the current screen brightness; and obtaining and playing back the video stream at the target definition. According to the method of the present disclosure, a suitable definition can be selected for the video stream based on the current screen brightness of the video playback device, so as to achieve dynamic adjustment of the definition of the video stream based on the current screen brightness and rational use of bandwidth costs, thereby reducing lag during the playback of the video stream, and ensuring the viewing experience of the video stream.

The video stream playback method of the present disclosure is applicable to an application scenario as shown in FIG. 1, where current screen brightness of a playback device 11 may be obtained; target definition of a video stream may be determined based on the current screen brightness; and the playback device 11 may obtain the video stream at the target definition from a server 12, and play back the video stream at the target definition. The video stream includes, but is not limited to, a video stream of a short video, a live video stream, and the like.

It should be noted that user information and data involved in the present application are information and data for which an authorization is obtained from the user or a full authorization is obtained from each party, and the collection, use, and processing of relevant data need to comply with relevant laws, regulations, and standards of relevant countries and regions, for which corresponding operation entries are provided for the user to choose to authorize or deny.

In addition, an automatic definition switch control may be displayed, and the user may choose whether to trigger the control. After the automatic definition switch control is triggered, the video stream playback method provided by the embodiments of the present disclosure can be performed.

The video stream playback method of the present disclosure is described in detail below with reference to specific embodiments.

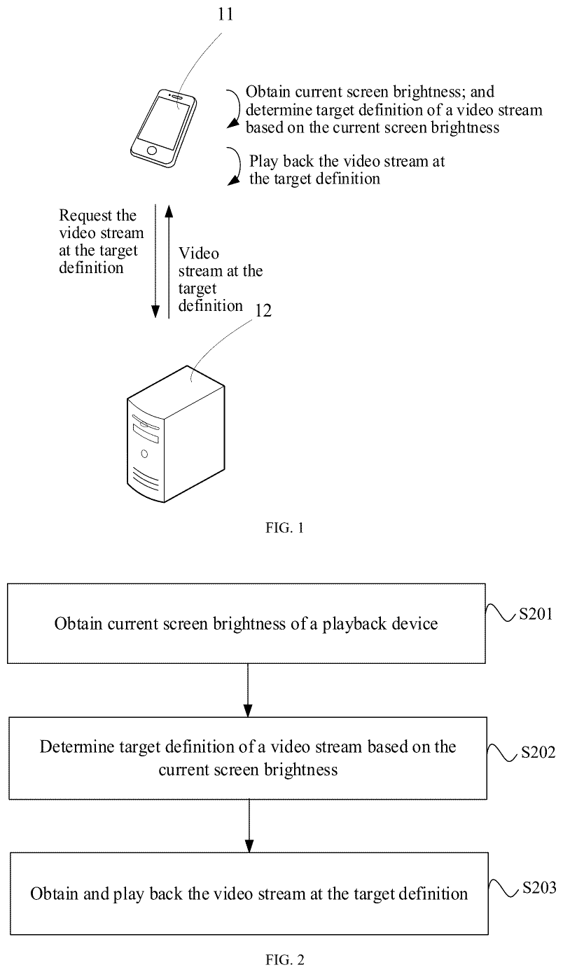

Referring to FIG. 2, FIG. 2 is a schematic flowchart of a video stream playback method according to some embodiments of the present disclosure. The method of this embodiment may be applied to a playback device capable of playing video streams, and the video stream playback method includes: steps S201 to S203.

S201: Obtain current screen brightness of a playback device.

In some embodiments, for playback devices with a display, the current screen brightness may be expressed in units of luminance, such as candelas per square meter (cd/m²) or nits. For playback devices such as projectors or laser televisions, the current screen brightness may be expressed in units of luminous flux, such as lumens or ANSI lumens.

In some embodiments, the current screen brightness is normalized, such that the current screen brightness is converted to an interval [0, 1]. For example, a ratio of the current screen brightness to a maximum screen brightness is obtained as normalized current screen brightness. In addition, the current screen brightness of the playback device may be obtained in response to a request from a user to obtain the current screen brightness of the playback device.

S202: Determine target definition of a video stream based on the current screen brightness.

In this embodiment, it is contemplated that the resolution of the video stream has little influence on the video viewing experience when the current screen brightness is low, while the resolution of the video stream has a significant influence on the video viewing experience when the current screen brightness is high. Therefore, when the current screen brightness is low, the video stream can be played at a low resolution (e.g., a first resolution) to avoid unnecessary data consumption and video lag. In contrast, when the current screen brightness is high, the video stream can be played at a high resolution (e.g., a second resolution, which is higher than the first resolution) to ensure the viewing experience of the video stream. Therefore, in this embodiment, a mapping relationship between different preset screen brightness and preset definition can be pre-configured, such that the preset definition corresponding to the current screen brightness can be determined as the target definition of the video stream based on the mapping relationship.

In some embodiments, by pre-configuring the mapping relationship between different preset screen brightness and preset definition, the screen brightness can be tiered into at least two levels: a high screen brightness level in the case of the screen brightness being greater than a preset brightness threshold, which corresponds to first definition (such as high definition); and a low screen brightness level in the case of the screen brightness being not greater than the preset brightness threshold, which corresponds to second definition (such as low definition), where the first definition is higher than the second definition. Of course, the screen brightness may also be tiered into more levels, and the above description is merely an example.

In some embodiments, if the current screen brightness is greater than the preset brightness threshold, the target definition is determined to be the first definition (of course, other definition values may also be used, and if a default definition of the playback device falls into a high-definition range, the target definition may be determined to be the default definition), such that the video stream is played at a high definition in the case of the high screen brightness level, thereby ensuring the viewing experience of the video stream. If the current screen brightness is not greater than the preset brightness threshold, the target definition is determined to be the second definition (of course, other definition values may also be used, and if a default definition of the playback device falls into a low-definition range, the target definition may be determined to be the default definition), such that the video stream is played at a low definition in the case of the low screen brightness level, thereby avoiding unnecessary data consumption and video lag.

In some embodiments, in the case that the current screen brightness is normalized, the target definition of the video stream may be determined based on the normalized current screen brightness, i.e., the preset brightness threshold in the above example also falls into the interval [0, 1], and then the normalized current screen brightness is compared against the preset brightness threshold to determine corresponding target definition.

S203: Obtain and play back the video stream at the target definition.

In this embodiment, the playback device may request video stream data of the target definition from a server after determining the target definition of the video stream, and play back the video stream data of the target definition.

The video stream playback method provided in this embodiment includes: obtaining current screen brightness of a playback device; determining target definition of a video stream based on the current screen brightness; and obtaining and playing back the video stream at the target definition. According to this embodiment, a suitable definition can be selected for the video stream based on the current screen brightness of the video playback device, so as to achieve dynamic adjustment of the definition of the video stream based on the current screen brightness and rational use of bandwidth costs, thereby reducing lag during the playback of the video stream, and ensuring the viewing experience of the video stream.

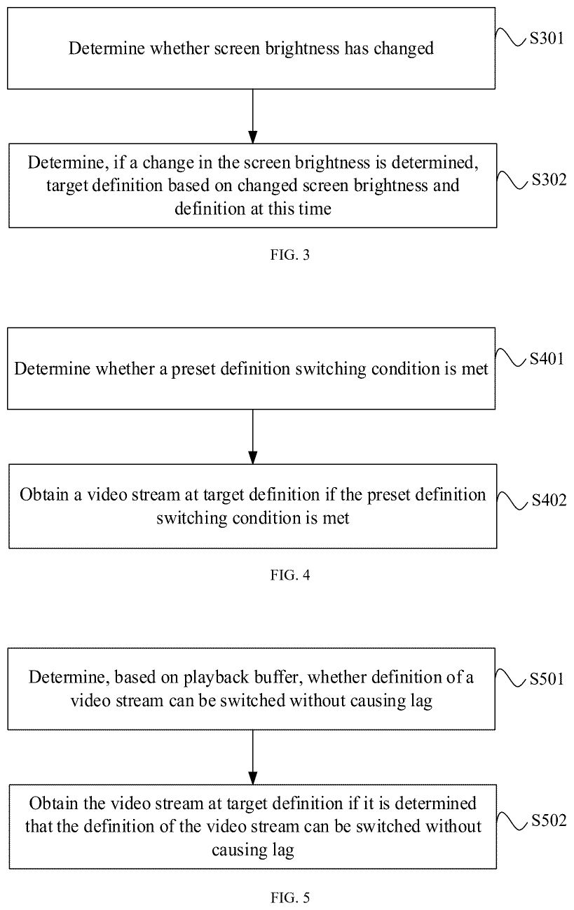

On the basis of any one of the above embodiments, as shown in FIG. 3, when determining the target definition of the video stream based on the current screen brightness in S202, the method may further include: steps S301 and S301.

S301: Determine whether screen brightness has changed.

S302: Determine, if a change in the screen brightness is determined, the target definition based on changed screen brightness and definition at this time (current definition).

In this embodiment, changes in screen brightness may be detected, and when a change in the screen brightness is detected, a change trend in the target definition can be determined. For example, when the screen brightness has changed from low brightness to high brightness, the target definition can be increased. When the screen brightness has changed from high brightness to low brightness, the target definition can be reduced. However, since there are different situations for the definition at this time (for example, the definition at this time may be a low definition, or a high definition), the target definition needs to be determined based on the changed screen brightness and the definition at this time. That is, if the definition at this time matches the changed screen brightness, the definition does not need to be adjusted, i.e., the target definition is equal to the definition at this time. If the definition at this time does not match the changed screen brightness, the definition needs to be adjusted, and a corresponding target definition needs to be selected based on the changed screen brightness.

In an optional embodiment, when determining the target definition based on the changed screen brightness and the definition at this time (the current definition), one or more of the following cases may be specifically included.

In the first case, if it is determined that the current screen brightness is greater than the preset brightness threshold, the changed screen brightness is not greater than the preset brightness threshold (i.e., the screen brightness is reduced), and the definition at this time is higher than a first preset definition threshold (which may be the second definition in the above embodiment, or another definition), the definition at this time does not meet the changed screen brightness. Then, the target definition may be determined to be third definition based on the changed screen brightness, where the third definition is not higher than the first preset definition threshold. That is, the definition of the video stream is reduced from being higher than the first preset definition threshold to being equal to or lower than the first preset definition threshold, i.e., the definition of the video stream is reduced from high definition to low definition.

In the second case, if it is determined that the current screen brightness is not greater than the preset brightness threshold, the changed screen brightness is greater than the preset brightness threshold (i.e., the screen brightness is increased), and the definition at this time is lower than a second preset definition threshold (the second preset definition threshold is higher than the first preset definition threshold, and may be the first definition in the above embodiment, or another definition), the definition at this time does not meet the changed screen brightness. Then, the target definition may be determined to be fourth definition based on the changed screen brightness, where the fourth definition is not lower than the second preset definition threshold. That is, the definition of the video stream is increased from being lower than the second preset definition threshold to being equal to or higher than the second preset definition threshold, i.e., the definition of the video stream is increased from low definition to high definition.

In the third case, if it is determined that the current screen brightness is greater than the preset brightness threshold, the changed screen brightness is not greater than the preset brightness threshold (i.e., the screen brightness is reduced), and the definition at this time is not higher than the first preset definition threshold, the definition at this time can meet the changed screen brightness. Then, the definition does not need to be adjusted (it can be considered that the target definition is equal to the definition at this time), and the video stream can continue to be played back at the definition at this time.

In the fourth case, if it is determined that the current screen brightness is not greater than the preset brightness threshold, the changed screen brightness is greater than the preset brightness threshold (i.e., the screen brightness is increased), and the definition at this time is not lower than the second preset definition threshold, the definition at this time can meet the changed screen brightness. Then, the definition does not need to be adjusted (it can be considered that the target definition is equal to the definition at this time), and the video stream can continue to be played back at the definition at this time.

When the screen brightness is changed, it can be determined which of the above cases is met currently, so as to determine whether it is necessary to switch the definition, and to determine the target definition if it is necessary to switch the definition.

On the basis of any one of the above embodiments, as shown in FIG. 4, obtaining the video stream at the target definition as described in S203 may include: steps S401 and S402.

S401: Determine whether a preset definition switching condition is met.

S402: Obtain the video stream at the target definition if the preset definition switching condition is met.

In this embodiment, when it is determined that the definition of the video stream needs to be switched, the condition required for switching the definition may not be met, especially when the video stream is switched from the low definition to the high definition where more network resources and device resources need to be occupied, thus it is also necessary to determine whether the playback device meets the preset definition switching condition. The preset definition switching condition includes, but is not limited to, a network condition, a device performance of the playback device, and the like. The definition switch may continue, i.e., the video stream at the target definition may be obtained and played, only if the preset definition switching condition is met; otherwise, the definition switch may be stopped, and the video stream may continue to be played back at the original definition.

On the basis of the above embodiment, the determining whether the preset definition switching condition is met includes:
determining whether a network state of the playback device meets a preset network condition; and/or
determining whether a performance state of the playback device meets a preset performance condition.

In this embodiment, the network state of the playback device may be obtained, where the network state of the playback device may be a real-time network state, such as a current upload/download bit rate, or a network state over a past period of time, such as a comprehensive determination of upload/download bit rates of all data over a past period of time. In addition, a preset upload/download bit rate may be used as the preset network condition, such that an upload/download bit rate is compared directly against the preset upload/download bit rate to determine whether the network state of the playback device meets the preset network condition. For example, a current network download bit rate DownloadBitRate of the playback device is compared against the preset download bit rate, where the preset download bit rate is a preset multiple, e.g., 1.1 times, of an average bit rate HighBitRate of a video stream at a high definition (e.g., the first definition). That is, the network state of the playback device meets the preset network condition when DownloadBitRate≥1.1*HighBitRate. The network state of the playback device may also be tiered into different levels (e.g., a first level, a second level, etc., where the first level is superior to the second level). If the network state of the playback device currently falls into some level (e.g., the first level), the network state of the playback device is determined to meet the preset network condition.

In addition, in this embodiment, the performance state of the playback device may also be obtained, where the performance state of the playback device is used to reflect a load level of the playback device, and may be any parameter capable of reflecting the load level of the playback device. The performance state of the playback device may be a real-time performance state, or a comprehensive determination of a performance state over a past period of time. In addition, a parameter value may be preset as the preset performance condition, and a parameter value of the performance state of the playback device may be directly compared against the preset parameter value to determine whether the performance state of the playback device meets the preset performance condition. The performance state of the playback device may also be tiered into different levels (e.g., a first level, a second level, etc., depending on the performance load level, where the first level is superior to the second level). If the performance state of the playback device currently falls into some level (e.g., the first level, etc.), the performance state of the playback device is determined to meet the preset performance condition.

By determining the network state and/or the performance state of the playback device, differentiated definition control and switch based on screen brightness changes, network conditions, and performance changes of the playback device can be achieved. It should be noted that it may not perform determination on the preset definition switching condition when the definition of the video stream needs to be reduced.

On the basis of the above embodiment, after determining that the playback device meets the preset definition switching condition, if the definition of the playback device cannot be smoothly switched, especially if lag will be caused when the definition is switched, the definition of the video stream will not be switched, i.e., the video stream continues to be played back at the original definition. The definition only continues to be switched when no lag will be caused by switching the definition. Therefore, as shown in FIG. 5, when obtaining the video stream at the target definition, the following steps are specifically included: steps S501 and S502.

S501: Determine, based on playback buffer, whether definition of the video stream can be switched without causing lag.

S502: Obtain the video stream at the target definition if it is determined that the definition of the video stream can be switched without causing lag.

In this embodiment, after the playback device is determined to meet the preset definition switching condition, before the definition of the video stream is actually switched, it can be determined whether the definition of the video stream can be switched without causing lag. It is contemplated that a certain time is required for a series of operations such as requesting video stream data at the switched definition after switching the definition of the video stream (an address of the video stream needs to be switched) and decoding the video stream data. During this time, the video stream can continue to be played at the original definition, and transitions to the video stream at the switched definition smoothly when the video stream at the switched definition can be played back normally, thereby avoiding lag of the video stream when the definition is switched. Therefore, the playback device needs to have sufficient playback buffer for the video stream at the original definition, so as to ensure a duration of the video stream at the original definition that is sufficient for use as buffer in the switching process. Therefore, in this embodiment, it can be determined whether the definition of the video stream can be switched without causing lag based on the playback buffer for the video stream by the playback device, that is, whether the playback device has sufficient playback buffer for the video stream at the original definition, and whether it can be ensured that there is a duration of the video stream at the original definition that is sufficient for use as buffer in the switching process. The playback buffer for the video stream may be determined by the playback device based on the buffer.

In some embodiments, a current playback buffer data amount for the video stream by the playback device at the definition at this time (the current definition) (the definition before the switch) is determined. A target playback buffer data amount for the video stream is determined, where the target playback buffer data amount is a data amount that can ensure a duration of the video stream at the original definition that is sufficient for use as buffer in the switching process. Further, the current playback buffer data amount can be compared against the target playback buffer data amount, and if the current playback buffer data amount is greater than or equal to the target playback buffer data amount, the playback device has sufficient playback buffer for the video stream at the original definition, which can ensure a duration of the video stream at the original definition that is sufficient for use as buffer in the switching process, thereby determining that the definition of the video stream can be switched without causing lag.

In some embodiments, the current playback buffer data amount for the video stream by the playback device at the definition at this time (the definition before the switch) is denoted as PlayBuffer. Determining the target playback buffer data amount for the video stream, including determining the target playback buffer data amount for the video stream based on an average video bit rate and a preset buffer duration of the video stream, is specifically as follows.

A product of the average video bit rate BitRate and the preset buffer duration N (a duration of the video stream data that is currently buffered, which may be in the unit of seconds) of the video stream is obtained, and determined as the target playback buffer data amount N*BitRate of the video stream.

If PlayBuffer>=N*BitRate, it is determined that the definition of the video stream can be switched without causing lag, and the definition switch can continue.

Of course, if the current playback buffer data amount is determined to be continuously less than the target playback buffer data amount for a preset duration (e.g., 5 seconds), it is determined that the definition of the video stream cannot be switched without causing lag, and the switch of the definition of the video stream is stopped. That is, in this embodiment, the determination as to whether the definition of the video stream can be switched without causing lag is kept within the preset duration at the maximum, and if the current playback buffer data amount has not yet reached the target playback buffer data amount when the preset duration is reached, the switch of the definition of the video stream is stopped, and the video stream continues to be played back at the original definition.

On the basis of any one of the above embodiments, after the definition of the video stream is switched, the lag status or smoothness of the video stream can be continuously monitored. When the lag status of the video stream meets a preset lag criterion, for example, an accumulated lag time reaches M seconds over a period of N seconds during playback, the video stream needs to be switched back to the original definition, and the video stream continues to be played back at the original definition, thereby ensuring smooth playback of the video stream.

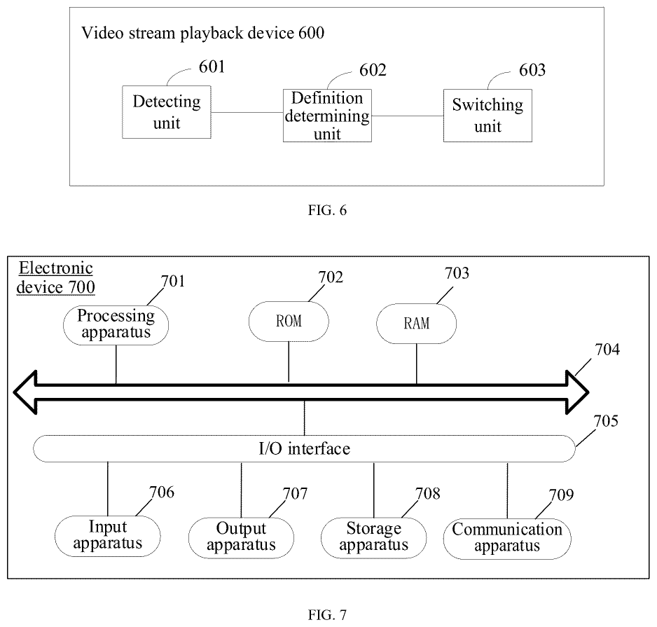

Corresponding to the video stream playback method in the above embodiment, FIG. 6 is a block diagram of a structure of a video stream playback device according to an embodiment of the present disclosure. For ease of illustration, only parts related to this embodiment of the present disclosure are shown. Referring to FIG. 6, the video stream playback device 600 includes: a detecting unit 601, a definition determining unit 602, and a switching unit 603.

The detecting unit 601 is configured to obtain current screen brightness of a playback device.

The definition determining unit 602 is configured to determine target definition of a video stream based on the current screen brightness.

The switching unit 603 is configured to obtain and play back the video stream at the target definition.

In one or more embodiments of the present disclosure, when determining the target definition of the video stream based on the current screen brightness, the definition determining unit 602 is configured to:
determine, based on the current screen brightness and a mapping relationship between preset screen brightness and preset definition, the preset definition corresponding to the current screen brightness as the target definition of the video stream.

In one or more embodiments of the present disclosure, when determining the target definition of the video stream based on the current screen brightness, the definition determining unit 602 is configured to:
determine the target definition to be a first definition if the current screen brightness is greater than a preset brightness threshold; or
determine the target definition to be second definition if the current screen brightness is not greater than the preset brightness threshold, where the first definition is higher than the second definition.

In one or more embodiments of the present disclosure, when determining the target definition of the video stream based on the current screen brightness, the definition determining unit 602 is configured to:
determine whether screen brightness has changed; and
determine, if a change in the screen brightness is determined, the target definition based on changed screen brightness and current definition.

In one or more embodiments of the present disclosure, when determining, if a change in the screen brightness is determined, the target definition based on the changed screen brightness and the current definition, the definition determining unit 602 is configured to:
determine the target definition to be third definition, if it is determined that the current screen brightness is greater than the preset brightness threshold, the changed screen brightness is not greater than the preset brightness threshold, and the current definition is higher than a first preset definition threshold, where the third definition is not higher than the first preset definition threshold; or
determine the target definition to be fourth definition, if it is determined that the current screen brightness is not greater than the preset brightness threshold, the changed screen brightness is greater than the preset brightness threshold, and the current definition is lower than a second preset definition threshold, where the fourth definition is not lower than the second preset definition threshold, and the first preset definition threshold is lower than the second preset definition threshold.

In one or more embodiments of the present disclosure, when obtaining the video stream at the target definition, the switching unit 603 is configured to:
determine whether a preset definition switching condition is met; and obtain the video stream at the target definition if the preset definition switching condition is met.

In one or more embodiments of the present disclosure, when determining whether the preset definition switching condition is met, the switching unit 603 is configured to:
determine whether a network state of the playback device meets a preset network condition; and/or
determine whether a performance state of the playback device meets a preset performance condition.

In one or more embodiments of the present disclosure, when obtaining the video stream at the target definition, the switching unit 603 is configured to:
determine, based on playback buffer, whether definition of the video stream can be switched without causing lag; and
obtain the video stream at the target definition if it is determined that the definition of the video stream can be switched without causing lag.

In one or more embodiments of the present disclosure, when determining, based on the playback buffer, whether the definition of the video stream can be switched without causing lag, the switching unit 603 is configured to:
determine a current playback buffer data amount for the video stream at the current definition in the playback buffer;
determine a target playback buffer data amount for the video stream; and
compare the current playback buffer data amount against the target playback buffer data amount, and determine that the definition of the video stream can be switched without causing lag if the current playback buffer data amount is greater than or equal to the target playback buffer data amount.

In one or more embodiments of the present disclosure, when determining the target playback buffer data amount for the video stream, the switching unit 603 is configured to:
determine the target playback buffer data amount for the video stream based on an average video bit rate and a preset buffer duration of the video stream.

In one or more embodiments of the present disclosure, when determining, based on the playback buffer, whether the definition of the video stream can be switched without causing lag, the switching unit 603 is further configured to:
determine that the definition of the video stream cannot be switched without causing lag if the current playback buffer data amount is determined to be continuously less than the target playback buffer data amount for a preset duration, and stop performing switch of the definition of the video stream.

In one or more embodiments of the present disclosure, when determining the target definition of the video stream based on the current screen brightness, the definition determining unit 602 is configured to: normalize the current screen brightness, and determine the target definition of the video stream based on normalized current screen brightness.

The device provided in this embodiment may be configured to perform the technical solution of the above method embodiment. The implementation principle and technical effects thereof are similar, and are not described herein again in this embodiment.

FIG. 7 is a schematic diagram of a structure of an electronic device 700 suitable for implementing the embodiments of the present disclosure. The electronic device 700 may be a terminal device or a server. The terminal device may include, but is not limited to, a mobile terminal such as a mobile phone, a notebook computer, a digital broadcast receiver, a personal digital assistant (PDA), a tablet computer (portable Android device, PAD), a portable media player (PMP), and a vehicle-mounted terminal (such as a vehicle navigation terminal), and a fixed terminal such as a digital TV and a desktop computer. The electronic device shown in FIG. 7 is merely an example, and shall not impose any limitation on the function and scope of use of the embodiments of the present disclosure.

As shown in FIG. 7, the electronic device 700 may include a processing apparatus (e.g., a central processing unit or a graphics processing unit) 701 that may perform a variety of appropriate actions and processing in accordance with a program stored in a read-only memory (ROM) 702 or a program loaded from a storage apparatus 708 into a random access memory (RAM) 703. The RAM 703 further stores various programs and data required for the operation of the electronic device 700. The processing apparatus 701, the ROM 702, and the RAM 703 are connected to one another through a bus 704. An input/output (I/O) interface 705 is also connected to the bus 704.

Generally, the following apparatuses may be connected to the I/O interface 705: an input apparatus 706 including, for example, a touchscreen, a touchpad, a keyboard, a mouse, a camera, a microphone, an accelerometer, and a gyroscope; an output apparatus 707 including, for example, a liquid crystal display (LCD), a speaker, and a vibrator; the storage apparatus 708 including, for example, a tape and a hard disk; and a communication apparatus 709. The communication apparatus 709 may allow the electronic device 700 to perform wireless or wired communication with other devices to exchange data. Although FIG. 7 shows the electronic device 700 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a computer-readable medium, where the computer program includes program code for performing the method shown in the flowchart. In such an embodiment, the computer program may be downloaded and installed from a network through the communication apparatus 709, installed from the storage apparatus 708, or installed from the ROM 702. When the computer program is executed by the processing apparatus 701, the above-mentioned functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to perform the method shown in the above embodiment.

The computer program code for performing the operations in the present disclosure may be written in one or more programming languages or a combination thereof, where the programming languages include an object-oriented programming language, such as Java, Smalltalk, or C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user via any kind of network, including a local area network (LAN) or a wide area network (WAN), or may be connected to an external computer (for example, connected via the internet with the aid of an internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two internet protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

In a first aspect, according to one or more embodiments of the present disclosure, a video stream playback method is provided. The method includes:
obtaining current screen brightness of a playback device;
determining target definition of a video stream based on the current screen brightness; and
obtaining and playing back the video stream at the target definition.

According to one or more embodiments of the present disclosure, the determining target definition of a video stream based on the current screen brightness includes:
determining, based on the current screen brightness and a mapping relationship between preset screen brightness and preset definition, the preset definition corresponding to the current screen brightness as the target definition of the video stream.

According to one or more embodiments of the present disclosure, the determining target definition of a video stream based on the current screen brightness includes:
determining the target definition to be first definition if the current screen brightness is greater than a preset brightness threshold; or
determining the target definition to be second definition if the current screen brightness is not greater than the preset brightness threshold, where the first definition is higher than the second definition.

According to one or more embodiments of the present disclosure, the determining target definition of a video stream based on the current screen brightness includes:
determining whether screen brightness has changed; and
determining, if a change in the screen brightness is determined, the target definition based on changed screen brightness and current definition.

According to one or more embodiments of the present disclosure, the determining, if a change in the screen brightness is determined, the target definition based on changed screen brightness and current definition includes:
determining the target definition to be third definition, if it is determined that the current screen brightness is greater than the preset brightness threshold, the changed screen brightness is not greater than the preset brightness threshold, and the current definition is higher than a first preset definition threshold, where the third definition is not higher than the first preset definition threshold; or
determining the target definition to be fourth definition, if it is determined that the current screen brightness is not greater than the preset brightness threshold, the changed screen brightness is greater than the preset brightness threshold, and the current definition is lower than a second preset definition threshold, where the fourth definition is not lower than the second preset definition threshold, and the first preset definition threshold is lower than the second preset definition threshold.

According to one or more embodiments of the present disclosure, the obtaining the video stream at the target definition includes:
determining whether a preset definition switching condition is met; and
obtaining the video stream at the target definition if the preset definition switching condition is met.

According to one or more embodiments of the present disclosure, the determining whether a preset definition switching condition is met includes:
determining whether a network state of the playback device meets a preset network condition; and/or
determining whether a performance state of the playback device meets a preset performance condition.

According to one or more embodiments of the present disclosure, the obtaining the video stream at the target definition includes:
determining, based on playback buffer, whether definition of the video stream can be switched without causing lag; and
obtaining the video stream at the target definition if it is determined that the definition of the video stream can be switched without causing lag.

According to one or more embodiments of the present disclosure, the determining, based on playback buffer, whether definition of the video stream can be switched without causing lag includes:
determining a current playback buffer data amount for the video stream at the current definition in the playback buffer;
determining a target playback buffer data amount for the video stream; and
comparing the current playback buffer data amount against the target playback buffer data amount, and determining that the definition of the video stream can be switched without causing lag if the current playback buffer data amount is greater than or equal to the target playback buffer data amount.

According to one or more embodiments of the present disclosure, the determining a target playback buffer data amount for the video stream includes:
determining the target playback buffer data amount for the video stream based on an average video bit rate and a preset buffer duration of the video stream.

According to one or more embodiments of the present disclosure, the determining, based on playback buffer, whether definition of the video stream can be switched without causing lag further includes:
determining that the definition of the video stream cannot be switched without causing lag if the current playback buffer data amount is determined to be continuously less than the target playback buffer data amount for a preset duration, and stopping performing switch of the definition of the video stream.

According to one or more embodiments of the present disclosure, the determining target definition of a video stream based on the current screen brightness includes:
normalizing the current screen brightness, and determining the target definition of the video stream based on normalized current screen brightness.

In a second aspect, according to one or more embodiments of the present disclosure, a video stream playback device is provided. The device includes:
a detecting unit configured to obtain current screen brightness of a playback device;
a definition determining unit configured to determine target definition of a video stream based on the current screen brightness; and
a switching unit configured to obtain and play back the video stream at the target definition.

According to one or more embodiments of the present disclosure, when determining the target definition of the video stream based on the current screen brightness, the definition determining unit is configured to:
determine, based on the current screen brightness and a mapping relationship between preset screen brightness and preset definition, the preset definition corresponding to the current screen brightness as the target definition of the video stream.

According to one or more embodiments of the present disclosure, when determining the target definition of the video stream based on the current screen brightness, the definition determining unit is configured to:
determine the target definition to be first definition if the current screen brightness is greater than a preset brightness threshold; or
determine the target definition to be second definition if the current screen brightness is not greater than the preset brightness threshold, where the first definition is higher than the second definition.

According to one or more embodiments of the present disclosure, when determining the target definition of the video stream based on the current screen brightness, the definition determining unit is configured to:
determine whether screen brightness has changed; and
determine, if a change in the screen brightness is determined, the target definition based on changed screen brightness and current definition.

According to one or more embodiments of the present disclosure, when determining, if a change in the screen brightness is determined, the target definition based on the changed screen brightness and the current definition, the definition determining unit is configured to:
determine the target definition to be third definition, if it is determined that the current screen brightness is greater than the preset brightness threshold, the changed screen brightness is not greater than the preset brightness threshold, and the current definition is higher than a first preset definition threshold, where the third definition is not higher than the first preset definition threshold; or
determine the target definition to be fourth definition, if it is determined that the current screen brightness is not greater than the preset brightness threshold, the changed screen brightness is greater than the preset brightness threshold, and the current definition is lower than a second preset definition threshold, where the fourth definition is not lower than the second preset definition threshold, and the first preset definition threshold is lower than the second preset definition threshold.

According to one or more embodiments of the present disclosure, when obtaining the video stream at the target definition, the switching unit is configured to:
determine whether a preset definition switching condition is met; and
obtain the video stream at the target definition if the preset definition switching condition is met.

According to one or more embodiments of the present disclosure, when determining whether the preset definition switching condition is met, the switching unit is configured to:
determine whether a network state of the playback device meets a preset network condition; and/or
determine whether a performance state of the playback device meets a preset performance condition.

According to one or more embodiments of the present disclosure, when obtaining the video stream at the target definition, the switching unit is configured to:
determine, based on playback buffer, whether definition of the video stream can be switched without causing lag; and
obtain the video stream at the target definition if it is determined that the definition of the video stream can be switched without causing lag.

According to one or more embodiments of the present disclosure, when determining, based on the playback buffer, whether the definition of the video stream can be switched without causing lag, the switching unit is configured to:
determine a current playback buffer data amount for the video stream at the current definition in the playback buffer;
determine a target playback buffer data amount for the video stream; and
compare the current playback buffer data amount against the target playback buffer data amount, and determine that the definition of the video stream can be switched without causing lag if the current playback buffer data amount is greater than or equal to the target playback buffer data amount.

According to one or more embodiments of the present disclosure, when determining the target playback buffer data amount for the video stream, the switching unit is configured to:
determine the target playback buffer data amount for the video stream based on an average video bit rate and a preset buffer duration of the video stream.

According to one or more embodiments of the present disclosure, when determining, based on the playback buffer, whether the definition of the video stream can be switched without causing lag, the switching unit is further configured to:
determine that the definition of the video stream cannot be switched without causing lag if the current playback buffer data amount is determined to be continuously less than the target playback buffer data amount for a preset duration, and stop performing switch of the definition of the video stream.

According to one or more embodiments of the present disclosure, when determining the target definition of the video stream based on the current screen brightness, the definition determining unit is configured to:
normalize the current screen brightness, and determine the target definition of the video stream based on normalized current screen brightness.

In a third aspect, according to one or more embodiments of the present disclosure, an electronic device is provided. The electronic device includes: at least one processor and a memory, where
the memory stores computer-executable instructions; and
the computer-executable instructions stored in the memory, when executed by the at least one processor, cause the at least one processor to perform the video stream playback method according to any one of the embodiments of the present disclosure.

In a fourth aspect, according to one or more embodiments of the present disclosure, a computer-readable storage medium is provided, where the computer-readable storage medium stores computer-executable instructions that, when executed by a processor, cause the video stream playback method according to any one of the embodiments of the present disclosure to be implemented.

In a fifth aspect, according to one or more embodiments of the present disclosure, a computer program product is provided, where the computer program product includes computer-executable instructions that, when executed by a processor, cause the video stream playback method according to any one of the embodiments of the present disclosure to be implemented.

In a sixth aspect, according to one or more embodiments of the present disclosure, a computer program is provided, where the computer program includes instructions that, when executed by a processor, cause the processor to implement the video stream playback method according to any one of the embodiments of the present disclosure.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A video stream playback method, comprising:
obtaining current screen brightness of a playback device;
determining target definition of a video stream based on the current screen brightness; and
obtaining and playing back the video stream at the target definition.

2. The video stream playback method according to claim 1, wherein the determining target definition of a video stream based on the current screen brightness comprises:
determining, based on the current screen brightness and a mapping relationship between preset screen brightness and preset definition, the preset definition corresponding to the current screen brightness as the target definition of the video stream.

3. The video stream playback method according to claim 1, wherein the determining target definition of a video stream based on the current screen brightness comprises:
determining the target definition to be first definition if the current screen brightness is greater than a preset brightness threshold; and
determining the target definition to be second definition if the current screen brightness is not greater than the preset brightness threshold, wherein the first definition is higher than the second definition.

4. The video stream playback method according to claim 1, wherein the determining target definition of a video stream based on the current screen brightness comprises:
determining whether screen brightness has changed; and
determining, if a change in the screen brightness is determined, the target definition based on changed screen brightness and current definition.

5. The video stream playback method according to claim 4, wherein the determining, if a change in the screen brightness is determined, the target definition based on changed screen brightness and current definition comprises:
determining the target definition to be third definition, if it is determined that the current screen brightness is greater than a preset brightness threshold, the changed screen brightness is not greater than the preset brightness threshold, and the current definition is higher than a first preset definition threshold, wherein the third definition is not higher than the first preset definition threshold; or
determining the target definition to be fourth definition, if it is determined that the current screen brightness is not greater than a preset brightness threshold, the changed screen brightness is greater than the preset brightness threshold, and the current definition is lower than a second preset definition threshold, wherein the fourth definition is not lower than the second preset definition threshold, and the first preset definition threshold is lower than the second preset definition threshold.

6. The video stream playback method according to claim 4, wherein the obtaining the video stream at the target definition comprises:
determining whether a preset definition switching condition is met; and
obtaining the video stream at the target definition if the preset definition switching condition is met.

7. The video stream playback method according to claim 6, wherein the determining whether a preset definition switching condition is met comprises at least one of:
determining whether a network state of the playback device meets a preset network condition; or
determining whether a performance state of the playback device meets a preset performance condition.

8. The video stream playback method according to claim 1, wherein the obtaining the video stream at the target definition comprises:
determining, based on playback buffer, whether definition of the video stream can be switched without causing lag; and
obtaining the video stream at the target definition if it is determined that the definition of the video stream can be switched without causing lag.

9. The video stream playback method according to claim 8, wherein the determining, based on playback buffer, whether definition of the video stream can be switched without causing lag comprises:
determining a current playback buffer data amount for the video stream at the current definition in the playback buffer;
determining a target playback buffer data amount for the video stream; and
comparing the current playback buffer data amount against the target playback buffer data amount, and determining that the definition of the video stream can be switched without causing lag if the current playback buffer data amount is greater than or equal to the target playback buffer data amount.

10. The video stream playback method according to claim 9, wherein the determining a target playback buffer data amount for the video stream comprises:
determining the target playback buffer data amount for the video stream based on an average video bit rate and a preset buffer duration of the video stream.

11. The video stream playback method according to claim 9, wherein the determining, based on playback buffer, whether definition of the video stream can be switched without causing lag further comprises:
determining that the definition of the video stream cannot be switched without causing lag if the current playback buffer data amount is determined to be continuously less than the target playback buffer data amount for a preset duration, and stopping performing switch of the definition of the video stream.

12. The video stream playback method according to claim 1, wherein the determining target definition of a video stream based on the current screen brightness comprises:
normalizing the current screen brightness, and determining the target definition of the video stream based on normalized current screen brightness.

13. (canceled)

14. An electronic device, comprising: at least one processor and a memory, wherein
the memory stores computer-executable instructions; and
the computer-executable instructions stored in the memory, when executed by the at least one processor, cause the at least one processor to perform the following video stream playback operations:
obtaining current screen brightness of a playback device;
determining target definition of a video stream based on the current screen brightness; and
obtaining and playing back the video stream at the target definition.

15. A non-transitory computer-readable storage medium storing computer-executable instructions that, when executed by a processor, cause to implement the following video stream playback operations:
obtaining current screen brightness of a playback device;
determining target definition of a video stream based on the current screen brightness; and
obtaining and playing back the video stream at the target definition.

16-17. (canceled)

18. The electronic device according to claim 14, wherein the determining target definition of a video stream based on the current screen brightness comprises:
determining, based on the current screen brightness and a mapping relationship between preset screen brightness and preset definition, the preset definition corresponding to the current screen brightness as the target definition of the video stream.

19. The electronic device according to claim 14, wherein the determining target definition of a video stream based on the current screen brightness comprises:
determining the target definition to be first definition if the current screen brightness is greater than a preset brightness threshold; and
determining the target definition to be second definition if the current screen brightness is not greater than the preset brightness threshold, wherein the first definition is higher than the second definition.

20. The electronic device according to claim 14, wherein the determining target definition of a video stream based on the current screen brightness comprises:
determining whether screen brightness has changed; and
determining, if a change in the screen brightness is determined, the target definition based on changed screen brightness and current definition.

21. The storage medium according to claim 15, wherein the determining target definition of a video stream based on the current screen brightness comprises:
determining, based on the current screen brightness and a mapping relationship between preset screen brightness and preset definition, the preset definition corresponding to the current screen brightness as the target definition of the video stream.

22. The storage medium according to claim 15, wherein the determining target definition of a video stream based on the current screen brightness comprises:
determining the target definition to be first definition if the current screen brightness is greater than a preset brightness threshold; and
determining the target definition to be second definition if the current screen brightness is not greater than the preset brightness threshold, wherein the first definition is higher than the second definition.

23. The storage medium according to claim 15, wherein the determining target definition of a video stream based on the current screen brightness comprises:
determining whether screen brightness has changed; and
determining, if a change in the screen brightness is determined, the target definition based on changed screen brightness and current definition.
